SEQUENCE LISTING (33 sequences)

SEQ ID NO: 1 - protein, 128 aa, Hydrogenoanaerobacterium saccharovorans
MSTEQKFFICKHCGNLIGMINNAGVKMMCCGEPMEELTPNTTDASQEKHVPVIEVKGDTVTVKIGSAPHPMLEEHHITWIYLQTEQGGQRKELTVGGDPSATFALTDGDKPVAAFEYCNLHGLWKASI

SEQ ID NO: 2 - protein, 127 aa, Anaerotignum lactatifermentans
MKAPRFFICKHCKNIITMVEDKGVPVVCCGEKMTELKANTSDGAGEKHVPVVQVEGSKVTVKVGEVTHPMLEEHHIAWIYLETSQGGQIKYLDHTGAPEAVFALAEGEQAVAAYEYCNLHGLWKAEI

SEQ ID NO: 3 - protein, 61 aa, Crocosphaera subtropica
MQKYICNVCNYIYDPAKGDPDSGIEPGTPFEAIPDDWECPQCGATKSQFEPYQADANVLTS

SEQ ID NO: 4 - protein, 188 aa, Armatimonadetes bacterium
MAELVSQEGTRMTVKVFRCRICGDPYIGTEAPSRCPFCGAKAEYFVDAHDWNPNEFNVDISDISRKNLEAALQLELGNAAFYLCAMNQAKSARDDYMEAKFKALRNVEFEHASAICKFLKMTVPVLEQGRCGADFADNSKEGHQREDKAIKSYARFRDEAVEPRLKEFFNALVEIETDHLGLHAADSH

SEQ ID NO: 5 - protein, 182 aa, Rhodospirillales bacterium
MPRRAPADAIALLKADHRKVENLFEKFQNAREDDRKRALVREICAELTIHAMIEEEIFYPACKGKIKDEELLDEGYVEHDGAKVLIAELLDGSPSDEFYDAKVTVLSEMIKHHVKEEERRSEGLFAQARDAGLDMEALRDRLMARKEELTSKFENGAKLPPPKTRSYTGHKLEQSQPVQVAA

SEQ ID NO: 6 - protein, 144 aa, Flavobacteriaceae bacterium
MNIFEAIRKDHDKQRELCKLVTSTSGDSKGRKEMWEKLKHELQVHADAEERTFYTPLIQNDMMQEHARHGIAEHHEMDELIEKIDDTDLDSPGWLVHVKQLCEKVEHHLEDEEHTFFQLAGKVFTEKQKTTIAEEYLKVMKEKR

SEQ ID NO: 7 - protein, 195 aa, Rhodococcus opacus
MADQQRDVIEVLTQDHREVERIFAELEGLTGADTRARRQDLVEQVTIELVKHSVAEEAEVYPAVRAKVSEAAAQRALGEHAEAEQTMKRLESMTPGDPGFDTELATLMREIRQHVAEEEGQMFADMRRVFSPEELVELGRKVEAVKKLAPTRPHPAAPDTPPGETILRPAAGLLDRLRDAVTGRGHSGSAGSPTR

SEQ ID NO: 8 - protein, 194 aa, Desulfitobacterium sp. LBE
MDFKDSKTFQNLVNGFAGESQARNRYTFYAGVAKNEGHQAIQNIFISTADNEKEHAKVFYKFLQKYAGDQTEVFRVNADYPLNYRDTLANLKSAAAGEGEEVIDYNTFADIADEEGYADIAVAFRKIATVEAHHQERYARLAAELENGTLYKKDQKISWKCENCGYVHEGSGAPDLCPACQHPQGYFKPLPEVY

SEQ ID NO: 9 - protein, 124 aa, Caproiciproducens sp.
MANVEFYRCEICGNMVVKIKNGGGTLVCCGQNMTKLTANSTDAAQEKHVPVVTRENGKIKVAVGSTLHPMLPEHHIEWIALVSGDRVELKYLQPGMQPVAEFKNAESGTVYEYCNLHGLWKADF

SEQ ID NO: 10 - protein, 124 aa, Gemmiger sp.
MEFYRCEHCGNIVAFLNKSGVPVVCCGEKMKLLEPGVVDAAVEKHLPVVAVNGRTVTVSVGSVAHPMTEEHLIQWVVLETSQGWQQKKLAAGDAPEVKFALAEGEAPVAAWAYCNLHGLWKTVI

SEQ ID NO: 11 - protein, 183 aa, Fusobacterium sp. HMSC073F01
MAKYRCKVCGEIITDESIDKCPVCKAGKDKWELVVEGTEKVWATEHVIGEGLACGDEEIIMGLRANFEGECTEVGMYLAMSRAADREGYPEIAEAYKRIAFEEAEHAAKFAELLGECVSASSEENLTKRVEAEYGATSGKFDLAKRAKMLGFDAIHDTVHEMAKDEARHGKAFVGLLNRYFGK

SEQ ID NO: 12 - protein, 126 aa, Thermodesulfobacterium commune
MAEKLGLYKCQVCGNIVLVMHGGKGQLVCCGKPMELQTPNTVDAAVEKHVPVIEKEGDVYKVKVGSVPHPMTEEHYIEWIELHADEDKVYIKFLKPGEAPEAVFEVKAAKVVAKEWCNLHGYWQGA

SEQ ID NO: 13 - protein, 126 aa, Adlercreutzia equolifaciens
MDVKFYKCMHCGNIAVKVFDAGVPLVCCGEKMVELVAGSQDAALEKHVPAVEVEGNKVVVNVGSVDHPMLEEHWIQFICLVTDKGYQIHPLAPGEAPHAEFVIAEGETPLKVYEHCNLHGLWVTEI

SEQ ID NO: 14 - protein, 125 aa, Patescibacteria group bacterium
MEKKQIYRCPICGNVVELVYVGGGTLVCCGQPMLLEEVKKSEEGNEKHLPVVNVNGNEVSVKVGSIPHPMTEEHFIQWIECMVGENVYKKELKPNEAAEAVFMVEGDTSNMIVRAYCNIHGLWQA

SEQ ID NO: 15 - protein, 131 aa, Ammonifex thiophilus
MTELYQVYKCNVCGNIVEVLHTGRGQLVCCGKPMELMAEKKEDVGQEKHVPVIEPRNGKIKVRVGEVPHPMEEAHYIEWIELHTGEHVERVHLKPGDQPEATFLCPFGTPLYARAYCNIHGLWRQDTFPKK

SEQ ID NO: 16 - protein, 126 aa, Orenia marismortui
MANQLREIYKCEHCGNVVEFVQAGPAPLVCCGENMVKLEAQTEDAANEKHVPVVEEIEGGVKVTVGTTLHPMTEEHLIRFIEVLTEDKVLRAELKAGDKPVAEFKVSKDEIVEVREFCNIHGLWKA

SEQ ID NO: 17 - protein, 126 aa, Butyricicoccus porcorum
MEQRYFVCEHCGNMIAMVEDKGVPVMCCGQKMTELVPGSVDAAQEKHVPVIAIDGNTVTVSVGSVDHPMLPEHFIEWISIHTTQGNQRKTLQPGSEPKAVFALADGDSVVSAYAYCNLHGLWKADA

SEQ ID NO: 18 - protein, 125 aa, Caldicellulosiruptor obsidiansis
MIKRGNVYKCEICGNIVEVLHAGGGQLVCCGKPMTLLEANTVDASLEKHVPVIEKTEEGILVKVGEVAHPMEEKHYIMWIELIADNKLYRKYLKPGDEPKALFEVSAESVVAYEYCNLHGLWKKE

SEQ ID NO: 19 - protein, 126 aa, Treponema succinifaciens
MQLKFYYCRHCGKIIAIVKDSGIPTVCCGEAMQELVPGTTDGSSEKHIPVIKVEGNTVSVTVGSKLHPSEAEHYIEWILLQTDKGIQQKWLRPGNSPSVDFAVMTGERVEAAYEYCNIHRLWKAEY

SEQ ID NO: 20 - protein, 121 aa, Magelona berkeleyi
MSDFKIPEPYIWDESFRVFYDNLDEEHKNLFKGIFNVAGDRGSQTNYDSLLKVVKHHFADEEGMMSKANYGGFAGHKAAHDDFVDKLSGLKTPLSDGDVNYAKEWLVNHIKGIDFKYKKQL

SEQ ID NO: 21 - protein, 185 aa, Clostridiales bacterium
MDGIALMVEEHKLIKRMLKVMRKASYILMKEDRYDDQDFRKMIDFVRNYADAHHHGKEEDFLFNRMISEIGGVAEKLVRNGMLVEHDLGRLHMKQLEEALNKVKSGDEEAKLDVIANAVSYTDLLTRHIDKEDKVAYTFAQKELKSDTIDMINEDCGRFEEKQKDKGVQDRYLKLVEEFEEKYLS

SEQ ID NO: 22 - protein, 181 aa, Anaerotruncus colihominis DSM 17241
MKKFVCTICGYVHEGDTPPEFCPQCKAPASKFEEQKTDGLTWADEHRIGVAAGVDAEIIEGLRMNFTGECTEVGMYLAMARQAHREGYPEIGLYYEKAAYEEAEHAAKFAELLGEVVYADTKKNLELRVAAENGACEGKKKIATRAKELGLDAIHDTVHEMAKDEARHGCGFQGLLNRYFK

SEQ ID NO: 23 - protein, 54 aa, Prevotella copri DSM 18205
MKKYVCDVCGWIYDPEVGDPEGGIASGTAFEDIPDDWVCPLCGVGKEDFSPVEE

SEQ ID NO: 24 - protein, 59 aa, Algiphilus aromaticivorans
MTASRKWQCAVCGFIYDEAVGLPEDGIPPGTAWDDVPDDWMCPDCSAPKSDFDMVEVAR

SEQ ID NO: 25 - protein, 63 aa, Mycolicibacterium aurum
MSGDEDFKLFVCVQCGFEYDEAKGWPEDGIAPGTRWDDIPEDWSCPDCGAAKTDFEMVEVARP

SEQ ID NO: 26 - protein, 57 aa, Burkholderiales bacterium JOSHI_001
MSEPRTWMCLICGWIFDEAAGDPEHGIAPGTAWADVPMNWTCPECGARKEDFEMVQI

SEQ ID NO: 27 - protein, 52 aa, Candidatus Methanoperedens nitroreducens
MAKYLCTVCNYIYDTEVGDPPQIKPGTALEDLPDDWVCPSCGVCSKDMFKKL

SEQ ID NO: 28 - protein, 61 aa, Collimonas fungivorans
MTETETEFKTLMCLVCGWIYSEKDGAPSEGLAAGTRWDDIPDTWTCPECGVKKEDFTMVEF

SEQ ID NO: 29 - protein, 53 aa, Prochlorococcus marinus str. MIT 9303
MKKYACKVCTYVYDPRVGDPTNGIPPGTSFADLPRDWKCPQCKVGKGKFKPCN

SEQ ID NO: 30 - protein, 201 aa, Tyzzerella nexilis
MASQLKTSKTKENLMKAFAGESQARNRYTFAAEEARKEGLYAVSQIFLFTAEQERAHAERFYELLKEMAGETIEICGGYPVDKQASTEELLYAAQHNEYEEADDVYQSFGDVAKEEGFMEVASAFYQIAKIEKVHGDRFGKLAELLKTGAYFECQEGEKWMCLNCGHIHSGLKVPGVCPVCRHERGYFIPVSLAPYLMECE

SEQ ID NO: 31 - protein, 181 aa, Methanobrevibacter thaueri
MTDLKGTKTEANLQAAFAGESQAHTKYQYFAAKAKEEGYVQIHDIFMETSKNEREHAKIWFKLLHDEEVPDTIANLNAAADGENEEWTAMYKEFAETAKEEGFPMIAFLFEKVGAIEKEHEERYRTLLANVENDAVFNKEEDIEWKCENCGFVFKGPNAPEKCPVCGLPKAHFEERATNFK

SEQ ID NO: 32 - protein, 227 aa, Echinopora forskaliana
MSVIKQVMKTKLHLEGTVNGHDFTIEGKGEGKPYEGLQHMKMTVTKGAPLPFSVHILTPSHMYGSKPFNKYPADIPDYHKQSFPEGMSWERSMIFEDGGVCTASNHSSINLQENCFIYDVKFHGVNLPPDGPVMQKTIAGWEPSVETLYVRDGMLKSDTAMVFKLKGGGHHRVDFKTTYKAKKPVKLPEFHFVEHRLELTKHDKDFTTWDQQEAAEGHFSPLPKALP

SEQ ID NO: 33 - protein, 20 aa, Artificial Sequence
  synthetic
MGSSHHHHHHSSGLVPRGSH

(19) United States
(12) Patent Application Publication
(10) Pub. No.: US 2024/0306679 A1
(43) Pub. Date: Sep. 19, 2024

(54) NON-HEME PROTEIN PIGMENTS FOR MEAT SUBSTITUTE COMPOSITIONS

(71) Applicant: Cargill, Incorporated, Wayzata, MN (US)

(72) Inventors: Nandita Kohli, Plymouth, MN (US); Hans Liao, Plymouth, MN (US); Christopher Kenneth Miller, Andover, MN (US); Brian Jeffrey Rush, Excelsior, MN (US)

(73) Assignee: Cargill, Incorporated, Wayzata, MN (US)

(21) Appl. No.: 18/571,934

(22) PCT Filed: Jun. 27, 2022
(86) PCT No.: PCT/US2022/073177

§ 371 Date: Dec. 19, 2023

Related U.S. Application Data
(60) Provisional application No. 63/217,562, filed on Jul. 1, 2021.

(51) Int. Cl. A23L 5/43; A23J 3/22; A23L 5/46

(52) U.S. Cl. CPC A23L 5/43; A23J 3/227; A23L 5/46

(57) ABSTRACT

Disclosed herein are pigment compositions for meat substitutes and meat substitutes including such pigment compositions. The pigment compositions include a non-heme iron-binding protein. The pigment compositions provide a pink and/or red color to a meat substitute composition. For example, the non-heme iron-binding protein my include a sequence at least 60%, at least 70%, at least 80%, at least 85%, at least 90%, at least 95%, at least 98%, or at least 99% identical to at least one of SEQ ID NOs: 1-31.

### CROSS-REFERENCE TO RELATED APPLICATIONS

This application claims priority to U.S. Provisional Patent Application No. 63/217,562, filed Jul. 1, 2021, which is incorporated herein by reference in its entirety.

### REFERENCE TO A SEQUENCE LISTING SUBMITTED VIA EFS-WEB

The content of the ASCII text file of the sequence listing named “PT-1116-WO-PCT ST25.txt” which is 37.7 kb in size created on Jun. 20, 2022 and electronically submitted via EFS-Web herewith the application is incorporated by reference in its entirety.

### BACKGROUND

Demand for plant-based meat substitutes is increasing for a variety of reasons. Many consumers prefer meat substitute options that perform most similarly to animal meat, including wanting the color of the meat substitute to be comparable to animal meat color before and after cooking. Accordingly, there is a need for a pigment that can provide color to a meat substitute that is the same or similar to that of natural animal meat. A pigment derived from natural sources is particularly desirable.

### SUMMARY

The present disclosure provides a meat substitute comprising at least 2.0% by weight of a non-meat protein, and 0.01% to 10.0% by weight of a non-heme iron-binding protein. Prior to cooking, the meat substitute may have increased red color relative to an equivalent meat substitute lacking the non-heme iron-binding protein. The non-heme iron-binding protein may be selected from the group consisting of a desulfoferrodoxin, a rubredoxin, a ferritin, a hemerythrin, a rebrerythrin, a reverse rubrerythrin, or a combination thereof. The non-heme iron-binding protein may be from Hydrogenoanaerobacterium saccharovorans, Anaerotignum lactatifermentans, Crocosphaera subtropica, Armatimonadetes bacterium, Rhodospirillales bacterium, Flavobacteriaceae bacterium, Rhodococcus opacus, Desulfitobacterium sp. LBE, Caproiciproducens sp., Gemmiger sp., or Fusobacterium sp. HMSC073F01. The non-heme iron-binding protein may comprise a sequence at least 60%, at least 70%, at least 80%, at least 85%, at least 90%, at least 95%, at least 98%, or at least 99% identical to at least one of SEQ ID NOs: 1-31. The non-heme iron-binding protein may comprise a sequence at least 60%, at least 70% at least 80%, at least 85%, at least 90%, at least 95%, at least 98%, or at least 99% identical to at least one of SEQ ID NOs: 1, 2, 3, 4, 7, 9, and 10. The non-heme iron-binding protein may comprise a sequence at least 60%, at least 70%, at least 80%, at least 85%, at least 90%, at least 95%, at least 98%, or at least 99% identical to at least one of SEQ ID NOs: 1, 4, 6, 7, and 8. The non-heme iron-binding protein may comprise a sequence at least 60%, at least 70%, at least 80%, at least 85%, at least 90%, at least 95%, at least 98%, or at least 99% identical to at least one of SEQ ID NOs: 2, 3, 9, and 10. The non-heme iron-binding protein may have an absorbance spectrum maximum between 450 nm and 600 nm.

For example, the meat substitute compositions described herein comprises a non-meat protein, e.g., a plant-based protein selected from the group consisting of pea protein, soy protein, corn protein, chickpea protein, and wheat protein. The non-meat protein comprises a fungal-derived protein, e.g., a fungal mycoprotein. The non-meat protein may comprise an insect protein. The non-meat protein may comprise an in vitro cultured animal cell. The meat substitute may comprise 0.01% to 6%, 0.05% to 5%, 0.1% to 3%, or 0.5% to 2% by weight of the non-heme iron binding protein. The meat substitute may comprise between 50% and 80%, between 55% and 75%, or between 58% and 70% by weight of water. The meat substitute may comprise between 1% and 10%, between 2% and 8%, between 3% and 8%, or between 4% and 7% by weight of a lipid composition. The lipid composition may comprise coconut oil, palm oil, sunflower oil, soy oil, canola oil, or combinations thereof. The meat substitute may comprise between 5% and 30%, between 8% and 25%, between 10% and 20%, or between 12% and 19% of a textured plant-based protein. The textured plant-based protein may comprise textured pulse protein, textured pea protein, textured soy flour, textured soy concentrate, textured wheat protein, potato protein, or combinations thereof. The meat substitute may comprise between 0.5% and 8%, between 1% and 6%, between 20% and 40%, or between 25% and 35% by weight of a powdered plant-based protein. The powdered plant-based protein may comprise pea protein isolate, soy flour, soy isolate, soy concentrate, vital wheat gluten, potato protein, corn protein isolate, or combinations thereof. The meat substitute may comprise methylcelluose in an amount up to 2% by weight or between 0.1% and 2% by weight. The meat substitute may comprise a pigment composition comprising the non-heme iron-binding protein and the pigment composition comprises at least 10%, 20%, 30%, 40%, 50%, 60%, 70%, 80%, 85%, 90%, 95%, or 99% of the non-heme iron-binding protein on a dry weight basis.

The disclosure further provides a pigment composition for a meat substitute comprising a non-heme iron-binding protein in an amount effective for increasing the red color of a meat substitute. The non-heme iron-binding protein may be selected from the group consisting of a desulfoferrodoxin, a rubredoxin, a ferritin, a hemerythrin, a rebrerythrin, a reverse rubrerythrin, or a combination thereof. The non-heme iron-binding protein may be from Hydrogenoanaerobacterium saccharovorans, Anaerotignum lactatifermentans, Crocosphaera subtropica, Armatimonadetes bacterium, Rhodospirillales bacterium, Flavobacteriaceae bacterium, Rhodococcus opacus, Desulfitobacterium sp. LBE, Caproiciproducens sp., Gemmiger sp., or Fusobacterium sp. HMSC073F01. The non-heme iron-binding protein may comprise a sequence at least 60%, at least 70%, at least 80%, at least 85%, at least 90%, at least 95%, at least 98%, or at least 99% identical to at least one of SEQ ID NOs: 1-31. The non-heme iron-binding protein may comprise a sequence at least 60%, at least 70% at least 80%, at least 85%, at least 90%, at least 95%, at least 98%, or at least 99% identical to at least one of SEQ ID NOs: 1, 2, 3, 4, 7, 9, and 10. The non-heme iron-binding protein may comprise a sequence at least 60%, at least 70%, at least 80%, at least 85%, at least 90%, at least 95%, at least 98%, or at least 99% identical to at least one of SEQ ID NOs: 1, 4, 6, 7, and 8. The non-heme iron-binding protein may comprise a sequence at least 60%, at least 70%, at least 80%, at least 85%, at least 90%, at least 95%, at least 98%, or at least 99% identical to at least one of SEQ ID NOs: 2, 3, 9, and 10. The non-heme iron-binding protein may have an absorbance spectrum maximum between 450 nm and 600 nm. The non-heme iron-binding protein may comprise a sequence at least 60%, at least 70%, at least 80%, at least 85%, at least 90%, at least 95%, at least 98%, or at least 99% identical to at least one of SEQ ID NOs: 2, 3, 9, and 10 and, when the pigment is heated at 80° C. for 20 minutes, the absorbance of light at absorbance spectrum maximum is at least 80% of the absorbance at the absorbance spectrum maximum prior to heating or greater than 100% of the absorbance at the absorbance spectrum maximum prior to heating. The non-heme iron-binding protein may comprise a sequence at least 80%, at least 85%, at least 90%, at least 95%, at least 98%, or at least 99% identical to at least one of SEQ ID NOs: 1, 4, 6, 7, and 8 and, when the pigment is heated at 80° C. for 20 minutes, the absorbance of light at absorbance spectrum maximum is less than 80% of the absorbance at the absorbance spectrum maximum prior to heating. The pigment composition may comprise at least 10%, 20%, 30%, 40%, 50%, 60%, 70%, 80%, 85%, 90%, 95%, or 99% of the non-heme iron-binding composition on a dry weight basis.

The disclosure further provides a plant, animal, or edible mushroom cell comprising an exogenous polynucleotide encoding an non-heme iron-binding polypeptide comprising a sequence at least 80% identical to at least one of SEQ ID NOs: 1-31, wherein the non-heme iron-binding polypeptide has an absorption spectrum maximum between 450 nm and 600 nm. The non-heme iron-binding polypeptide may comprise a sequence at least 60%, at least 70%, at least 80%, at least 85%, at least 90%, at least 95%, at least 98%, or at least 99% identical to at least one of SEQ ID NOs:1-31. The edible mushroom cell may be a Fusarium venenatum cell. The cell may be an animal cell, e.g., an insect cell or an in vitro cultured mammalian or avian cell. Also provided are meat substitute composition comprising said cells.

The disclosure also provides a plasmid comprising a polynucleotide sequence encoding a non-heme iron-binding polypeptide comprises a sequence at least 60%, at least 70%, at least 90%, least 85%, at least 90%, at least 95%, at least 98%, or at least 99% identical to at least one of SEQ ID NOs: 1-31.

The disclosure further provides a method for increasing the red color of a meat substitute, the method comprising adding between 0.1% and 10.0% by weight of a non-heme iron-binding protein to a meat substitute comprising a non-meat protein to form a meat substitute with increased red color prior to cooking relative to an equivalent meat substitute without the non-heme iron-binding protein. The pigment composition may be any pigment composition described herein.

The disclosure also provides a method for increasing the red color of a cured meat substitute, the method comprising adding between 0.1% and 10.0% by weight of a non-heme iron-binding protein to a cured meat substitute comprising a non-meat protein to form a cured meat substitute with increased red color prior to cooking relative to an equivalent cured meat substitute without the non-heme iron-binding protein.

### BRIEF DESCRIPTION OF THE FIGURES

This patent or application contains at least one drawing executed in color. Copies of this patent or patent application publication with color drawings will be provided by the Office upon request and the payment of the necessary fee.

The drawings illustrate generally, by way of example, but not by way of limitation, various aspects discussed in the present document.

FIG. 1 shows the results of high throughput screening of 138 non-heme iron containing proteins.

FIG. 2 shows color and thermostability of 9 non-heme iron binding proteins identified in the high throughput screen of FIG. 1.

FIG. 3 shows absorbance spectra for the rubredoxin from Crocosphaera subtropica 105 before and after heating at 80° C. for 20 minutes followed by 100° C. for 20 minutes.

FIG. 4 shows a small-scale application model of a meat substitute composition prior to cooking (i.e., raw).

FIG. 5 shows a small-scale application model of a meat substitute composition after cooking at 130° C. for 2 minutes.

FIG. 6 shows Hunter colorimetry reflectance data for the beef and Meat Substitute Sample #1 small-scale applications shown in FIG. 4 and FIG. 5.

FIG. 7 shows Hunter colorimetry reflectance data for the Meat Substitute Sample #2, beet juice concentrate, and water small-scale applications shown in FIG. 4 and FIG. 5.

FIG. 8 shows Hunter colorimetry reflectance data for the 105 and 101 small-scale applications shown in FIG. 4 and FIG. 5.

FIG. 9 shows Hunter colorimetry reflectance data for the 107 and 117 small-scale applications shown in FIG. 4 and FIG. 5.

FIG. 10 shows Hunter colorimetry reflectance data for the 119 and 103 small-scale applications shown in FIG. 4 and FIG. 5.

FIG. 11 shows Hunter colorimetry reflectance data for the 113 small-scale applications shown in FIG. 4 and FIG. 5.

### DETAILED DESCRIPTION

Described herein are pigment compositions for meat substitutes that contain a non-heme iron-binding protein. Red colored non-heme iron-binding proteins may be used in a pigment composition having a similar red/pink color mimicking animal-based meat products. Meat substitutes containing an effective amount of this pigment composition will transition from a red color when raw to a more brown or less red color when cooked. In an aspect, the brown color results from Maillard reactions involving other components of the meat substitute which may become more visible upon cooking the meat substitute.

Unless defined otherwise, all technical and scientific terms used herein have the same meaning as commonly understood by one skilled in the art to which this invention belongs. As used herein, each of the following terms has the meaning associated with it as defined below.

As used herein, the terms “meat substitute” and “meat substitute composition” are used interchangeably and refer to compositions that mimic the general appearance, nutritional content, and/or taste of natural animal meat or natural animal meat compositions without containing as the majority component tissues or cells from a whole, living vertebrate animal. For example, the meat substitute may be free of, or contain as a minor component, naturally-occurring animal muscle, adipose, or satellite cells from muscle tissues harvested from a whole vertebrate animal (e.g, a cow, a sheep, a pig, a chicken, a turkey, etc.). In some aspects, the meat substitute is free of any animal cells, e.g., any in vivo derived or in vitro cultured animal cells.

The meat substitutes and meat substitute compositions described herein include non-meat proteins, plant-based proteins (e.g., pea protein, soy protein, wheat protein, chickpea protein, corn protein, and the like), fungal-based proteins (e.g., mycoproteins derived from fungi such as Fusarium venenatum and the like), in vitro cultured animal cells (e.g., cultured muscle cells, satellite cells, adipose cells, and the like), insect proteins, or combinations thereof. The meat substitute can comprise plant-based proteins including, but not limited to, pea protein, soy protein, wheat protein, chickpea protein, and corn protein. The meat substitute can comprise fungal based proteins including, but not limited to, mycoproteins from Fusarium venenatum. The meat substitute can comprise in vitro cultured animal cells including, but not limited to, muscle cells, satellite cells, and adipose cells grown, differentiated and propagated using, for example, fermentation, a bioreactor, scaffold-seeded cell culture, or other artificial methods. The meat substitute can comprise a combination of two or more of plant-based protein, fungal-based proteins, insect proteins and in vitro cultured animal cells. For example, a meat substitute may include a pea protein and a fungal mycoprotein, a soy protein and a cultured bovine muscle cell, a cultured avian adipocyte and a fungal mycoprotein, or any other combination of plant-base protein, fungal-based protein, insect proteins, and in vitro cultured animal cells.

In some aspects, the meat substitute comprises plant-based proteins, fungal-based proteins, or combinations thereof and is free of any animal-based proteins or cells. In some aspects, the meat substitute comprises plant-based proteins, fungal-based proteins, insect proteins, and combinations thereof and is free of and any vertebrate animal-based cells or proteins. In some aspects, the meat substitute comprises plant-based proteins and is free of fungal-based, insect, or animal-based cells or proteins. In some aspects, the meat substitutes comprises fungal-based proteins and is free of plant-based, insect, and animal-based cells and proteins. In aspect, the meat substitute comprises insect proteins and is free of plant-based, fungal-based, and animal-based cells and proteins. In some aspects, the meat substitute comprises in vivo cultured animal cells and is free of plant-based proteins, fungal-based proteins, insect proteins, and in vivo whole animal derived tissues, cells, and proteins.

In some aspects, the meat substitute can mimic a beef product, e.g., ground beef, steak, beef jerky, beef ribs, beef patties, beef sausages, and the like. In some aspects, the meat substitute can mimic a pork product, e.g., ground pork, pork chops, ham, smoked pork, bacon, pork sausage, pork patties, pork ribs, and the like. In some aspects, the meat substitute can mimic a chicken product, e.g., ground chicken, chicken breast, check legs, chicken thighs, chicken wings, chicken patties, chicken tenders, chicken nuggets, chicken sausage, and the like. In some aspects, the meat substitute can mimic a turkey product, e.g., ground turkey, turkey sausage, turkey patties, and the like. In some aspects, the meat substitute can mimic a shellfish product, e.g., crab, lobster, shrimp, crayfish, clams, scallops, oysters, mussels, and the like. In some aspects, the meat substitute can mimic a cured, salted, or processed meat product, e.g., charcuterie, salami, summer sausage, prosciutto, bologna, kielbasa, and the like.

As used herein, the term “non-meat protein” refers to protein sourced from plants, fungus, insects, dairy products, or in vitro cultured animal cells, and excludes in vivo vertebrate animal derived tissues, cells, or proteins. For example, non-meat proteins may include plant-based proteins, fungal-based proteins, insect proteins, milk proteins (e.g., casein and whey), proteins from in vitro cultured animal cells, or combinations thereof.

As used herein, the terms “polypeptide” and “peptide” are used interchangeably and refer to the collective primary, secondary, tertiary, and quaternary amino acid sequence and structure necessary to give the recited macromolecule its function and properties. As used herein, “enzyme” or “biosynthetic pathway enzyme” refer to a protein that catalyzes a chemical reaction. The recitation of any particular enzyme, either independently or as part of a biosynthetic pathway is understood to include the co-factors, co-enzymes, and metals necessary for the enzyme to properly function. A summary of the amino acids and their three and one letter symbols as understood in the art is presented in Table 1. The amino acid name, three letter symbol, and one letter symbol are used interchangeably herein.

TABLE 1
Amino Acid three and one letter symbols

| Amino Acid | Three letter symbol | One letter symbol |
|---|---|---|
| Alanine | Ala | A |
| Arginine | Arg | R |
| Asparagine | Asn | N |
| Aspartic acid | Asp | D |
| Cysteine | Cys | C |
| Glutamic acid | Glu | E |
| Glutamine | Gln | Q |
| Glycine | Gly | G |
| Histidine | His | H |
| Isoleucine | Ile | I |
| Leucine | Leu | L |
| Lysine | Lys | K |
| Methionine | Met | M |
| Phenylalanine | Phe | F |
| Proline | Pro | P |
| Serine | Ser | S |
| Threonine | Thr | T |
| Tryptophan | Trp | W |
| Tyrosine | Tyr | Y |
| Valine | Val | V |

As used herein, the term “non-heme iron-binding protein” refers to a polypeptide that binds iron but does not include a heme co-factor. For example, non-heme iron-binding proteins include 4-hydroxyphenylpyruvate dioxygenase, hemerythrin, ferroxidase, desulfoferrodoxin, desulfoferrodox domain-containing, bacteriohemerythrin, ferritin, transferrin, symethrin, superoxide reductase, sulerythrin, serotransferrin, rus, rubrerythrin-1, rubrerythrin-2, rubredoxin-like domain-containing, rubredoxin, reverse reubrerythrin, rebrerythrin, oyotransferrin, and nigerythrin proteins. In general, non-heme iron binding proteins suitable for use in the pigment compositions and meat substitutes described herein will be pink/red/brown in color as characterized by an absorbance spectrum maximum between 450 nm and 600 nm. Non-heme iron-binding proteins suitable for use in the pigment compositions described herein include, but are not limited to, non-heme iron-binding polypeptides with at least 60%, at least 70%, at least 80%, at least 85%, at least 90%, at least 95%, at least 98%, or at least 99% sequence identity to any one of SEQ ID NOs:1-31. The source organisms and accession codes (GenBank or Uniprot) for SEQ ID NOs: 1-31 are recited in Table 3 of Example 1. The non-heme iron-binding protein can be a thermolabile polypeptide or a thermostable polypeptide. In some aspects, the non-heme iron-binding polypeptide is at least 60%, at least 70%, at least 80%, at least 85%, at least 90%, at least 95%, at least 98%, or at least 99% identical to any one of SEQ ID NOs: 1, 2, 3, 4, 7, 9, and 10. In some aspects, the non-heme iron-binding polypeptide is a thermolabile polypeptide at least 60%, at least 70%, at least 80%, at least 85%, at least 90%, at least 95%, at least 98%, or at least 99% identical to any one of SEQ ID NOs: 1, 6, 4, 7, and 8. In some aspects, the non-heme iron-binding polypeptide is a thermostable polypeptide at least 60%, at least 70%, at least 80%, at least 85%, at least 90%, at least 95%, at least 98%, or at least 99% identical to any one of SEQ ID NOs: 2, 3, 9, and 10.

As used herein, the term “thermostable” refers to a polypeptide, e.g., a non-heme iron-binding protein, that, when heated at 80° C. for 20 minutes, retains at least 80% absorbance at its absorbance spectrum maximum as compared to the absorbance at the absorbance spectrum maximum prior to heating. For example, AlacDFX has an absorbance spectrum maximum at 506 nm and upon heating at 80° C. for 20 minutes, the heated AlacDFX retains at least 80% of the absorbance at 506 nm compared to the absorbance prior to heating. In some aspects, the absorbance after heating can be greater than 100% of the absorbance prior to heat. In other words, the thermostable non-heme iron binding protein may have a higher absorbance at its absorbance spectrum maximum after heating than it did before.

As used herein, the term “thermolabile” refers to a polypeptide, e.g., a non-heme iron-binding protein, that, when heated at 80° C. for 20 minutes, has a decrease in absorbance at its absorbance spectrum maximum as compared to the absorbance at the absorbance spectrum maximum prior to heating. For example, a thermolabile polypeptide may have a decrease in absorbance of at least 20%, at least 25%, at least 30%, at least 40%, at least 50%, at least 60%, at least 70%, or at least 80% relative to the absorbance prior to heating. After heating, the thermolabile polypeptide may have an absorbance at its absorbance spectrum maximum less than 80%, less than 70%, less than 60%, less then 50%, or less than 40% of the absorbance at the absorbance spectrum maximum prior to heating.

Variants or sequences having substantial identity or homology with the polypeptides described herein can be utilized in the practice of the disclosed pigments, compositions, and methods. Such sequences can be referred to as variants or modified sequences. That is, a polypeptide sequence can be modified yet still retain the ability to exhibit the desired activity. Generally, the variant or modified sequence may include or greater than about 45%, 45%, 50%, 55%, 60%, 65%, 70%, 75%, 80%, 85%, 90%, or 95% sequence identity with the wild-type, naturally occurring polypeptide sequence, or with a variant polypeptide as described herein.

As used herein, the phrases “% sequence identity.” “% identity.” and “percent identity.” are used interchangeably and refer to the percentage of residue matches between at least two amino acid sequences or at least two nucleic acid sequences aligned using a standardized algorithm. Methods of amino acid and nucleic acid sequence alignment are well-known. Sequence alignment and generation of sequence identity include global alignments and local alignments which are carried out using computational approaches. An alignment can be performed using BLAST (National Center for Biological Information (NCBI) Basic Local Alignment Search Tool) version 2.2.31 software with default parameters. Amino acid % sequence identity between amino acid sequences can be determined using standard protein BLAST with the following default parameters: Max target sequences: 100: Short queries: Automatically adjust parameters for short input sequences: Expect threshold: 10; Word size: 6; Max matches in a query range: 0; Matrix: BLOSUM62: Gap Costs: (Existence: 11, Extension: 1): Compositional adjustments: Conditional compositional score matrix adjustment: Filter: none selected: Mask: none selected. Nucleic acid % sequence identity between nucleic acid sequences can be determined using standard nucleotide BLAST with the following default parameters: Max target sequences: 100: Short queries: Automatically adjust parameters for short input sequences: Expect threshold: 10: Word size: 28: Max matches in a query range: 0; Match/Mismatch Scores: 1, −2: Gap costs: Linear: Filter: Low complexity regions: Mask: Mask for lookup table only. A sequence having an identity score of XX % (for example, 80%) with regard to a reference sequence using the NCBI BLAST version 2.2.31 algorithm with default parameters is considered to be at least XX % identical or, equivalently, have XX % sequence identity to the reference sequence.

Polypeptide or polynucleotide sequence identity may be measured over the length of an entire defined polypeptide sequence, for example, as defined by a particular SEQ ID number, or may be measured over a shorter length, for example, over the length of a fragment taken from a larger, defined polypeptide sequence, for instance, a fragment of at least 15, at least 20, at least 30, at least 40, at least 50, at least 70 or at least 150 contiguous residues. Such lengths are exemplary only, and it is understood that any fragment length supported by the sequences shown herein, in the tables, figures or Sequence Listing, may be used to describe a length over which percentage identity may be measured.

The polypeptides disclosed herein may include “variant” polypeptides, “mutants,” and “derivatives thereof.” As used herein the term “wild-type” is a term of the art understood by skilled persons and means the typical form of a polypeptide as it occurs in nature as distinguished from variant or mutant forms. As used herein, a “variant,” “mutant,” or “derivative” refers to a polypeptide molecule having an amino acid sequence that differs from a reference protein or polypeptide molecule. A variant or mutant may have one or more insertions, deletions, or substitutions of an amino acid residue relative to a reference molecule.

The amino acid sequences of the polypeptide variants, mutants, derivatives, or fragments as contemplated herein may include conservative amino acid substitutions relative to a reference amino acid sequence. For example, a variant, mutant, derivative, or fragment polypeptide may include conservative amino acid substitutions relative to a reference molecule. “Conservative amino acid substitutions” are those substitutions that are a substitution of an amino acid for a different amino acid where the substitution is predicted to interfere least with the properties of the reference polypeptide. In other words, conservative amino acid substitutions substantially conserve the structure and the function of the reference polypeptide. Conservative amino acid substitutions generally maintain (a) the structure of the polypeptide backbone in the area of the substitution, for example, as a beta sheet or alpha helical conformation, (b) the charge and/or hydrophobicity of the molecule at the site of the substitution, and/or (c) the bulk of the side chain.

As used herein, terms “polynucleotide.” “polynucleotide sequence,” and “nucleic acid sequence.” and “nucleic acid,” are used interchangeably and refer to a sequence of nucleotides or any fragment thereof. These phrases also refer to DNA or RNA of natural or synthetic origin, which may be single-stranded or double-stranded and may represent the sense or the antisense strand. The DNA polynucleotides may be a cDNA or a genomic DNA sequence.

A polynucleotide is said to encode a polypeptide if, in its native state or when manipulated by methods known to those skilled in the art, it can be transcribed and/or translated to produce the polypeptide or a fragment thereof. The anti-sense strand of such a polynucleotide is also said to encode the sequence.

Those of skill in the art understand the degeneracy of the genetic code and that a variety of polynucleotides can encode the same polypeptide. In some aspects, the polynucleotides (i.e., polynucleotides encoding a non-heme iron-binding protein polypeptide) may be codon-optimized for expression in a particular cell including, without limitation, a plant cell, bacterial cell, fungal cell, or animal cell. While polypeptides encoded by polynucleotide sequences found in coral are disclosed herein any polynucleotide sequences may be used which encodes a desired form of the polypeptides described herein. Thus, non-naturally occurring sequences may be used. These may be desirable, for example, to enhance expression in heterologous expression systems of polypeptides or proteins. Computer programs for generating degenerate coding sequences are available and can be used for this purpose. Pencil, paper, the genetic code, and a human hand can also be used to generate degenerate coding sequences.

Also provided herein are polynucleotides encoding a non-heme iron-binding polypeptide described herein. The polynucleotide may encode any of the non-heme iron-binding polypeptides described herein, for example, the polynucleotide may encode a polypeptide with a sequence at least 60%, at least 70%, at least 80%, at least 85%, at least 90%, at least 95%, at least 98%, or at least 99% identical to any one of SEQ ID NOs: 1-31 and having an absorbance spectrum maximum between 450 nm and 600 nm.

The polypeptides described herein may be provided as part of a construct. As used herein, the term “construct” refers to recombinant polynucleotides including, without limitation, DNA and RNA, which may be single-stranded or double-stranded and may represent the sense or the antisense strand. Recombinant polynucleotides are polynucleotides formed by laboratory methods that include polynucleotide sequences derived from at least two different natural sources or they may be synthetic. Constructs thus may include new modifications to endogenous genes introduced by, for example, genome editing technologies. Constructs may also include recombinant polynucleotides created using, for example, recombinant DNA methodologies. The construct may be a vector including a promoter operably linked to the polynucleotide encoding the thermolabile non-heme iron-binding polypeptide. As used herein, the term “vector” refers to a polynucleotide capable of transporting another polynucleotide to which it has been linked. The vector may be a plasmid, which refers to a circular double-stranded DNA loop into which additional DNA segments may be integrated.

Cells including any of the polynucleotides, constructs, or vectors described herein are also provided. The cell may be a procaryotic cell or a eukaryotic cell. Suitable procaryotic cells include bacteria cell, for example, Escherichia coli and Bacillus subtilis cells. Suitable eukaryotic cells include, but are not limited to, fungal cells, plant cells, and animal cells. Suitable fungal cells include, but are not limited to, Fusarium venenatum, Pichia pastoris, Saccharomyces cerevisiae, Kluyveromyces lactis, Kluyveromyces marxianus, Yarrowia lipolytica, Trichomderma reesei, Issatchenkia orientalis, and Aspergillus niger cells. Suitable plant cells include, but are not limited to, a pea cell (Pisum sativum), a corn cell (Zea mays), a soy bean cell (Glycine max), and a wheat cell (Triticum sp.). Suitable animal cells include, but are not limited to, muscle cells (e.g., myocytes, myoblasts, myosatellite, and satellite cells) and fat cells (e.g., adipocytes or adipocyte progenitor cells such as mesenchymal stem cells). Suitable animal cells may be mammalian (e.g., bovine, porcine, and ovine), avian (e.g., poultry), crustacean (e.g., shrimp, lobster, and crab), mollusk (e.g., clam, mussel, scallop, and oyster) or insect cells. In some aspects, the cell is an edible mushroom cell, which refers to a mushroom that is safe for human consumption. For example, the edible mushroom cell can be a Fusarium venenatum, Agaricus bisporus, Lentinula edodes, or Volvariella volvacea cell.

Described herein are pigment compositions containing a non-heme iron-binding polypeptide, and meat substitutes including such pigment compositions. The pigment compositions disclosed herein can be used to provide color to a meat substitute that is similar to the color of natural animal meat when raw. In some aspects, these pigment compositions can change color upon heating and can provide an overall color change to the entire meat substitute composition that mimics the effects of cooking on natural animal meat. In an aspect, the pigment composition provides a pink and/or red color to raw, uncooked meat substitute that transitions to a brown, white, colorless, or less red color after cooking the meat substitute.

In some aspects, these pigment compositions can change color upon heating and can provide an overall color change to the entire meat substitute composition that mimics the effects of cooking on natural animal meat. The pigment composition itself loses its pink or red color as it is cooked due to degradation and may become colorless if enough degradation occurs. Accordingly, the brown color of a cooked meat substitute is not necessarily due to the pigment composition turning brown in color, but instead due to the pigment composition losing its reddish color. The degraded pigment composition in the cooked meat substitute no longer masks the other colors of the meat substitute and the brown colors associated with Maillard reactions in the meat substitute become more apparent. The redness of the pigment composition is reduced substantially or eliminated when heated to a temperature within a range typically used for cooking meat. The pigment composition changes from a pink and/or red color to a less-pink/red color or becomes substantially colorless when heated at 80° C. for 20 minutes. The pigment composition can be used to change the color of a meat substitute from a pink and/or red color to a brown color and/or less pink/red color, as exhibited by heating a meat substitute including the pigment composition at 80° C. for 20 minutes. The changes in color of a pigment composition sample can be measured using a Hunter Colorimeter and reported as a relative percent change in visible light absorbance after heating as compared to the sample prior to heating. When the thermolabile non-heme iron-binding polypeptide, the pigment composition, or the meat substitute is heated on a hot plate at 130° C. for 90 seconds, the a* value of L*a*b* colorimetry of the pigment composition decreases relative to the a* value prior to heating. The a* value may decrease by at least 5%, at least 10%, at least 15%, at least 20%, at least 25%, at least 30%, at least 35%, at least 40%, at least 45%, or at least 50%. Likewise, when the thermolabile non-heme iron-binding polypeptide, the pigment composition, or the meat substitute is heated at 80° C. for 20 minutes the absorbance of light at a wavelength of 506 nm is decreased relative to the absorbance prior to heating. The absorbance at 506 nm may decrease by at least 5%, at least 10%, at least 15%, at least 20%, at least 25%, at least 30%, at least 35%, at least 40%, at least 45%, or at least 50%.

The pigment compositions described herein include a non-heme iron-binding protein. The pigment composition may include a protein selected from the group consisting of 4-hydroxyphenylpyruvate dioxygenase, hemerythrin, ferroxidase, desulfoferrodoxin, desulfoferrodox domain-containing, bacteriohemerythrin, ferritin, transferrin, symethrin, superoxide reductase, sulerythrin, serotransferrin, rus, rubrerythrin-1, rubrerythrin-2, rubredoxin-like domain-containing, rubredoxin, reverse reubrerythrin, rebrerythrin, ovotransferrin, and nigerythrin with an absorbance spectrum maximum between 450 nm and 600 nm. For example, the pigment composition may include a non-heme iron-binding polypeptide with at least 80%, at least 85%, at least 90%, at least 95%, at least 98%, or at least 99% sequence identity to any one of SEQ ID NOs: 1-31. The pigment composition may include a non-heme iron-binding polypeptide with at least 80%, at least 85%, at least 90%, at least 95%, at least 98%, or at least 99% sequence identity to any one of SEQ ID NOs: 1, 2, 3, 4, 7, 9, and 10. The pigment composition may include a non-heme iron-binding polypeptide with at least 80%, at least 85%, at least 90%, at least 95%, at least 98%, or at least 99% sequence identity to any one of SEQ ID NOs: 1, 4, 6, 7, and 8. The pigment composition may include a non-heme iron-binding polypeptide with at least 80%, at least 85%, at least 90%, at least 95%, at least 98%, or at least 99% sequence identity to any one of SEQ ID NOs: 2, 3, 9, and 10.

The pigment composition can be included in a meat substitute at a level that provides increased or improved pink and/or red color in the meat substitute, while also providing increased or improved brown color in the meat substitute after cooking. In an aspect, the non-heme iron-binding protein is used at a level of at least 0.01%, 0.05%, 0.1%, 0.2%, 0.3%, 0.4%, 0.5%, 1.0%, 1.25%, or 1.5% on a wet (total) weight basis in a meat substitute composition. The pigment composition may be used at a level such that the non-heme iron-binding protein is in the range of 0.01% to 6%, 0.05% to 5%, 0.1% to 3%, or 0.5% to 2% by weight in a meat substitute composition.

The pigment composition may additionally include a carrier or a diluent. The pigment composition may also include a blend of the RCP polypeptide with another color or pigment. For example, the pigment composition may include the RCP polypeptide and a fruit or vegetable extract-based pigment composition.

The pigment composition described herein can be used as a pigment in any meat substitute composition. In general, a meat substitute composition describe herein includes a non-meat protein (e.g., a plant-based protein), and optionally includes water, a lipid composition, fiber, starch, a gelling agent (e.g., methylcellulose), a preservative, a flavor, or combinations thereof. The meat substitute may be in a form that mimics a ground and formed meat (e.g., ground beef, sausage, or another meat product in which the raw meat has been ground and reformed), a deli or emulsified meat (e.g., hot dogs, bologna, and other processed meats), or a whole muscle (e.g., chicken breast, steak, and the like that are whole muscles from an animal). The meat substitute may include a textured plant-based protein, a powdered plant-based protein, a plant-based protein isolate, or combinations thereof. The meat substitute may include between 2% and 30%, between 5% and 25%, between 8% and 20%, or between 10% and 19% by weight of a textured plant-based protein. The meat substitute may include between 0.5% and 8%, between 1% and 6%, between 20% and 40%, or between 25% and 35% by weight of a powdered plant-based protein or plant-based protein isolate.

As used herein, “textured protein” and “textured plant-based protein” are used interchangeably and refer to edible food ingredients processed from an edible protein sources and characterized by having a structural integrity and identifiable structure such that individual units, appearing as fibers, shreds, chunks, bits, granules, slices, and the like, will withstand hydration and cooking or other procedures used in the production of food for consumption. In general, textured plant-based proteins are used to mimic the texture of meat and bind water in the meat substitute compositions. Edible protein sources from which textured proteins are produced may include, but are not limited to, legumes (e.g., pulse protein), pea, soy, corn, wheat, chickpea, potato, and the like. Textured proteins may include, but are not limited to, textured pulse protein, textured pea protein, textured soy flour, textured soy concentrate, textured wheat protein, textured potato protein, or combinations thereof. Methods for protein texturization and known and described in the art, and may include, for example, high temperature and pressure extrusion, spinning, freeze texturization, chemical or enzymatic texturization, and the like.

Meat substitutes described herein may also include a non-textured plant-based protein, for example, a powdered plant-based protein, a plant-based protein isolate, a plant-protein based flour, a plant-protein concentrate, combinations thereof, and the like. Powdered plant-based proteins and plant-based protein isolates can include soluble forms of plant-based proteins used as food ingredients. Non-textured plant-based proteins may include, but are not limited to, pea protein, defatted soy flour, defatted soy isolate, soy concentrate, vital wheat gluten, potato protein, corn protein isolate, or combinations thereof.

The meat substitute may include a high moisture textured plant-based protein. In general, high moisture textured plant-based proteins are hydrated prior to addition to a meat substitute formulation and therefore may constitute a higher percentage thereof on a weight basis of the meat substitute composition. For example, the meat substitute composition may include between 25% and 98%, between 50% and 95%, or between 60% and 90% by weight of a high moisture textured plant-based protein.

The meat substitute may include one or more lipid compositions, for example a fat, an oil, or combinations thereof. In general, fats refer to lipid compositions that are solid at room temperature, whereas oils are liquid at room temperature. The lipid compositions may include saturated fatty acids (also referred to as “saturated fats”), unsaturated fatty acids (also referred to as “unsaturated fats”), or combinations thereof. The lipid composition may include, but are not limited to, vegetable oil, coconut oil, palm oil, sunflower oil, soy oil, canola oil, or combinations thereof. The meat substitute composition may include between 1% and 25%, between 1.5% and 20%, between 2% and 15%, between 2.5% and 10%, between 3% and 8%, or between 4% and 7% by weight of a lipid composition.

In some aspects, the meat substitute may include a lipid mimetic instead of or in addition to a lipid composition described herein. As used herein, the term “lipid mimetic” refers to a compound or composition that mimics the form, function, texture, mouthfeel, and taste of a lipid composition when used as a food ingredient. A lipid mimetic for use in the meat substitute composition describe herein may include, but is not limited to, a fiber, a starch, a carbohydrate, a protein, or combinations thereof. In some aspect, the lipid mimetic may be a plant extract. The meat substitute composition may include between 1% and 25%, between 1.5% and 20%, between 2% and 15%, between 2.5% and 10%, between 3% and 8%, or between 4% and 7% by weight of a lipid mimetic. When the lipid mimetic is used in combination with a lipid composition, the meat substitute may include between 1% and 25%, between 1.5% and 20%, between 2% and 15%, between 2.5% and 10%, between 3% and 8%, or between 4% and 7% by weight of the combination of the lipid mimetic and the lipid composition.

The meat substitute may include water. For example, the meat substitute may include between 50% (wt) and 80% (wt), between 55% (wt) and 75% (wt), or between 58% (wt) and 70% (wt) of water.

The meat substitute may include fiber. The fiber may include, but is not limited to, pectin, apple fiber, psyllium, flax fiber, rice bran extract, Konjac flour, and the like. The meat substitute may include between 0.1% (wt) and 3% (wt), between 0.1% (wt) and 2% (wt), or between 0.5% (wt) and 2% (wt) of fiber. The meat substitute may include fiber in an amount up to 1% (wt), up to 1.5% (wt), up to 2% (wt), up to 2.5% (wt), or up to 3% (wt).

The meat substitute may include starch. The starch may include a pregelatinized starch, a modified starch, or combinations thereof. The starch may include, but is not limited to, corn starch, potato starch, tapioca starch, and the like. The meat substitute may include between 0.1% (wt) and 3% (wt), between 0.1% (wt) and 2% (wt), or between 0.5% (wt) and 2% (wt) of starch. The meat substitute may include starch in an amount up to 1% (wt), up to 1.5% (wt), up to 2% (wt), up to 2.5% (wt), or up to 3% (wt).

The meat substitute may include a gelling agent. The gelling agent may include, but is not limited to, methylcellulose, egg white protein, casein, pectin, hydrocolloids (e.g. guar gum, xanthan gum, locust bean gum, and the like), soy protein, canola protein, a crosslinking enzyme (e.g., transglutaminase), and combinations thereof. The meat substitute may include between 0.1% (wt) and 3% (wt), between 0.1% (wt) and 2% (wt), or between 0.5% (wt) and 2% (wt) of a gelling agent. The meat substitute may include a gelling agent in an amount up to 1% (wt), up to 1.5% (wt), up to 2% (wt), up to 2.5% (wt), or up to 3% (wt).

In some aspects, the gelling agent is methylcellulose. The meat substitute may include between 0.1% (wt) and 3% (wt), between 0.1% (wt) and 2% (wt), or between 0.5% (wt) and 2% (wt) of methylcellulose. The meat substitute may include methylcellulose in an amount up to 1% (wt), up to 1.5% (wt), up to 2% (wt), up to 2.5% (wt), or up to 3% (wt).

The meat substitute may include a preservative. For example, the meat substitute may include a preservative such as potassium sorbate, cultured dextrose, vinegar, and the like.

The meat substitute may include a pigment. Pigments for meat substitute compositions are known and described in the art and may include, but are not limited to, fruit and vegetable extracts (e.g., beet juice and beet extracts), heme containing proteins, and the like.

The meat substitute may include a flavor or seasoning. For example, the meat substitute may include a natural or artificial flavor and/or a seasoning. Seasonings may include, but are not limited to, yeast extract, spices, paprika, garlic (e.g., garlic powder, minced garlic, dehydrated garlic), onion (e.g., onion powder, minced onion, dehydrated onion), oregano, parsley, sweetener, salt (e.g., sodium chloride or potassium chloride), cayenne, chili powder, cumin, ginger, and the like.

The meat substitute may include a sweetener. Suitable sweeteners are known and described in the art. The sweetener can be at least one of a non-caloric sweetener or a caloric sweetener. The sweetener can be any type of sweetener, for example, a sweetener obtained from a plant or plant product, or a physically or chemically modified sweetener obtained from a plant, or a synthetic sweetener.

An exemplary, but non-limiting, meat substitute composition is a composition which comprises: plant protein (e.g., textured pea protein and/or pea protein), water, vegetable oil, flavor ingredients, salt, sugar, binders, and the pigment composition described herein. The pigment composition described herein can also be used in food applications other than meat substitutes.

Meat substitutes described herein may include one or more cells comprising an exogenous polynucleotide encoding a non-heme iron-binding polypeptide as described herein. For example, the meat substitutes may include a fungal, plant, or animal cell as described herein comprising an exogenous polynucleotide encoding a non-heme iron-binding polypeptide described herein.

Also provided is a method for increasing the red or pink color of a meat substitute. The method for increasing the red color of a meat substitute may include adding a pigment composition comprising a non-heme iron-binding polypeptide to a non-meat protein to form a meat substitute with increased red color prior to cooking relative to an equivalent meat substitute without the pigment composition. Suitable non-heme iron-binding polypeptides include, but are not limited to, any non-heme iron-binding polypeptide described herein. For example, the non-heme iron-binding polypeptide may be a polypeptide at least 80% identical to at least one of SEQ ID NOs: 1-31.

Also provided is a method for increasing the red color of a cured meat substitute. The method for increasing the color of a cured meat substitute may include adding a pigment composition comprising an non-heme iron-binding polypeptide to a non-meat protein to form a cured meat substitute with increased red color prior relative to an equivalent cured meat substitute without the pigment composition. Suitable non-heme iron-binding polypeptides include, but are not limited to, any non-heme iron-binding polypeptide described herein. For example, the non-heme iron-binding polypeptide may be a polypeptide at least 80% identical to at least one of SEQ ID NOs: 1-31.

Also provided is a method for decreasing red color in a cooked meat substitute. The method for decreasing the red color in a cooked meat substitute includes cooking a meat substitute comprising a non-meat protein and a non-heme iron-binding polypeptide, whereby red color of the cooked meat substitute is reduced relative to the meat substitute prior to cooking. The non-heme iron-binding polypeptide may be any non-heme iron-binding polypeptide as described herein. For example, the non-heme iron-binding polypeptide to be added to the meat substitute may comprise a sequence at least 80% identical to any one of SEQ ID NOs: 1-31.

### EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather should be construed to encompass any and all variations which become evident as a result of the teaching provided herein.

### Example 1: Non-Heme Iron Protein Screening

138 candidate non-heme iron-binding proteins from diverse sources were selected for screening in E. coli cells. A breakdown of the protein families represented by the 138 candidate genes is outlined in Table 2.

TABLE 2
Candidate non-heme iron proteins

| Non-heme iron-binding | Number of candidate |
|---|---|
| protein classification | genes screened |
| 4-hydroxyphenylpyruvate dioxygenase | 9 |
| Hemerythrin | 30 |
| Ferroxidase | 3 |
| Desulfoferrodoxin | 31 |
| Desulfoferrodox domain-containing protein | 1 |
| Bacteriohemerythrin | 4 |
| Ferritin | 5 |
| Transferrin | 5 |
| Symethrin | 1 |
| Superoxide reductase | 1 |
| Sulerythrin | 1 |
| Serotransferrin | 2 |
| Rus | 1 |
| Rubrerythrin-2 | 3 |
| Rubrerythrin-1 | 3 |
| Rubredoxin-like domain-containing protein | 1 |
| Rubredoxin | 17 |
| Reverse Rubrerythrin | 5 |
| Rebrerythrin | 11 |
| Ovotransferrin | 1 |
| Nigerythrins | 1 |
| Hypothetical protein | 1 |

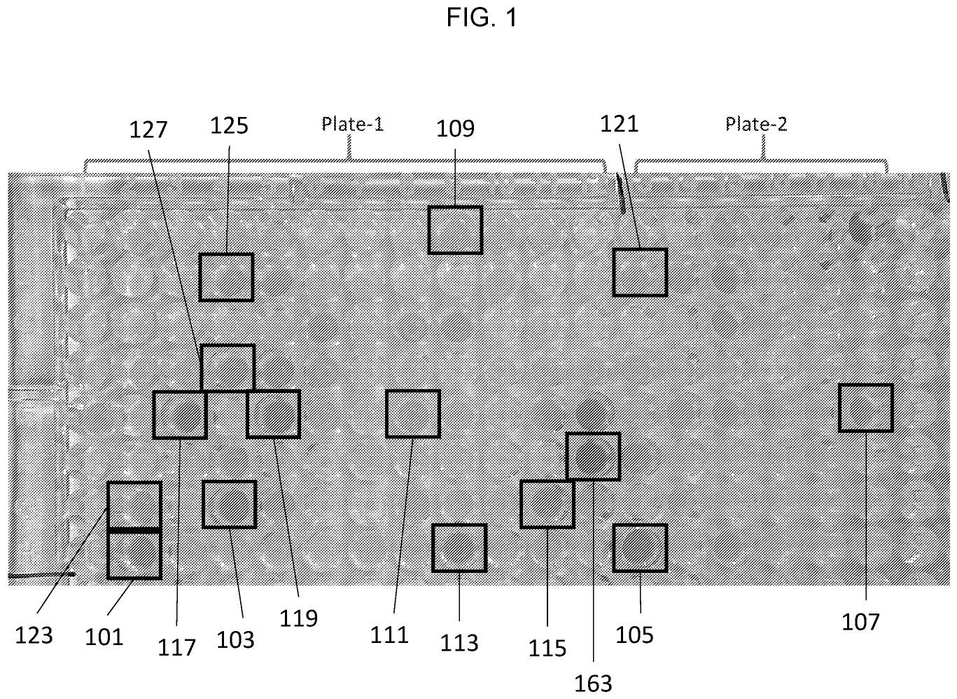

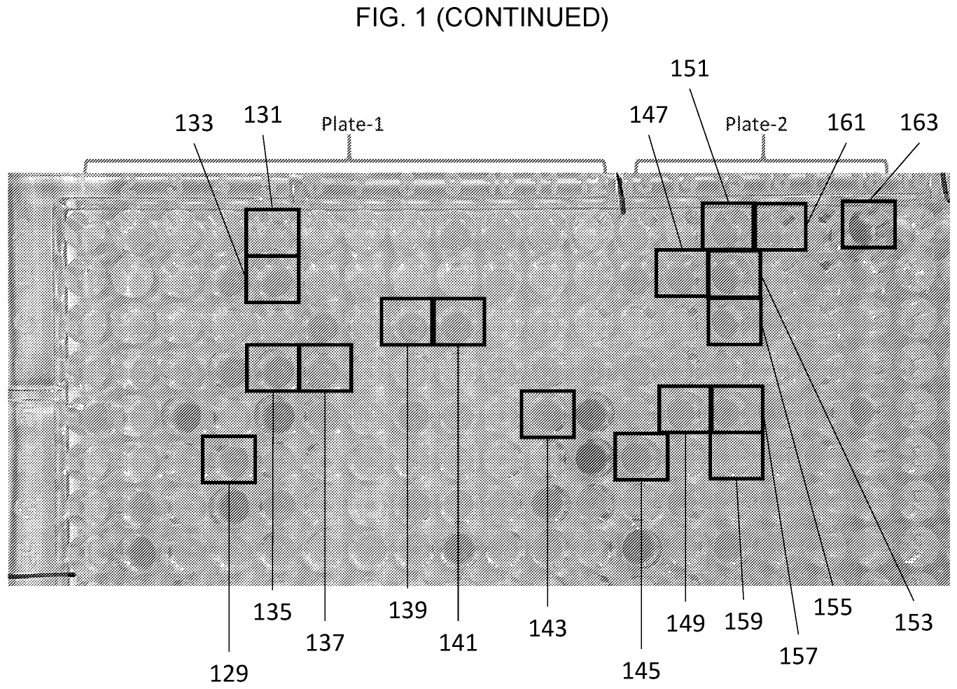

Candidate genes were expressed in E. coli cells, lysed, and the lysates observed for their color. Cell lysates that appeared pink/red/brown in color were selected for further screening. A list of the 31 lysates that were hits for the pink/red/brown color are outlined in Table 3 and the lysates are shown in FIG. 1. Lysates shown in FIG. 1 are labeled with a reference number as outlined in Table 3.

TABLE 3

| Reference | | | | Accession number | | SEQ |
|---|---|---|---|---|---|---|
| number | Protein | Plate | Well | (UniProt, unless specified) | Organism | ID NO: |
| 101 | Desulfoferrodoxin | Plate 1 | H2 | A0A1H7YRU6 | Hydrogenoanaerobacterium saccharovorans | 1 |
| 103 | Desulfoferrodoxin | Plate 1 | G4 | A0A1M6LOQ2 | Anaerotignum lactatifermentans | 2 |
| 105 | Rubredoxin | Plate 2 | H1 | WP_009545607.1 | Crocosphaera subtropica | 3 |
| | | | | (GenBank) | | |
| 107 | Ferritin | Plate 2 | E6 | A0A1F3B924_9BACT | Armatimonadetes bacterium | 4 |
| 109 | Hemerythrin | Plate 1 | A9 | A0A1E4HQ51 | Rhodospirillales bacterium | 5 |
| 111 | Hemerythrin | Plate 1 | E8 | A0A2D9BGQ4 | Flavobacteriaceae bacterium | 6 |
| 113 | Hemerythrin | Plate 1 | H9 | A0A2S8IXL3 | Rhodococcus opacus | 7 |
| 115 | Rebrerythrin | Plate 1 | G11 | A0A562HJF3_9FIRM | Desulfitobacterium sp. LBE | 8 |
| 117 | Desulfoferrodoxin | Plate 1 | E3 | A0A410Q4R2 | Caproiciproducens sp. | 9 |
| 119 | Desulfoferrodoxin | Plate 1 | E5 | A0A1Y3S0B8 | Gemmiger sp. | 10 |
| 121 | Reverse Rubrerythrin | Plate 2 | B1 | A0A1E9INR6_9FUSO | Fusobacterium sp. HMSC073F01 | 11 |
| 123 | Desulfoferrodoxin | Plate 1 | G2 | A0A101FJF9 | Thermodesulfobacterium commune | 12 |
| 125 | Desulfoferrodoxin | Plate 1 | B4 | A0A3E2ESL4 | Adlercreutzia equolifaciens | 13 |
| 127 | Desulfoferrodoxin | Plate 1 | D4 | A0A3C1IY50 | Patescibacteria group bacterium | 14 |
| 129 | Desulfoferrodoxin | Plate 1 | F4 | A0A3D8P3V7 | Ammonifex thiophilus | 15 |
| 131 | Desulfoferrodoxin | Plate 1 | A5 | A0A4R8GYS5 | Orenia marismortui | 16 |
| 133 | Desulfoferrodoxin | Plate 1 | B5 | A0A252F4S0 | Butyricicoccus porcorum | 17 |
| 135 | Desulfoferrodoxin | Plate 1 | D5 | D9TK29 | Caldicellulosiruptor obsidiansis | 18 |
| 137 | Desulfoferrodoxin | Plate 1 | D6 | F2NRP1 | Treponema succinifaciens | 19 |
| 139 | Hemerythrin | Plate 1 | C8 | A0A1S6QD10 | Magelona berkeleyi | 20 |
| 141 | Hemerythrin | Plate 1 | C9 | A0A3D5R6E4 | Clostridiales bacterium | 21 |
| 143 | Rebrerythrin | Plate 1 | E11 | B0PB57_9FIRM | Anaerotruncus colihominis DSM 17241 | 22 |
| 145 | Rubredoxin | Plate 2 | F1 | EFB34321.1 (GenBank) | Prevotella copri DSM 18205 | 23 |
| 147 | Rubredoxin | Plate 2 | B2 | WP_043769847.1 | Algiphilus aromaticivorans | 24 |
| | | | | (GenBank) | | |
| 149 | Rubredoxin | Plate 2 | E2 | WP_048630333.1 | Mycolicibacterium aurum | 25 |
| | | | | (GenBank) | | |
| 151 | Rubredoxin | Plate 2 | A3 | EHR73039.1 (GenBank) | Burkholderiales bacterium JOSHI 001 | 26 |
| 153 | Rubredoxin | Plate 2 | B3 | KCZ73047.1 (GenBank) | Candidatus Methanoperedens nitroreducens | 27 |
| 155 | Rubredoxin | Plate 2 | C3 | AMO92771.1 (GenBank) | Collimonas fungivorans | 28 |
| 157 | Rubredoxin | Plate 2 | E3 | ABM79495.1 (GenBank) | Prochlorococcus marinus str. MIT 9303 | 29 |
| 159 | Rubrerythrin-1 | Plate 2 | H3 | A0A6N2VGX0_9FIRM | Tyzzerella nexilis | 30 |
| 161 | Rubrerythrin-1 | Plate 2 | A4 | A0A315XPL7_9EURY | Methanobrevibacter thaueri | 31 |
| 163 | EforRed, Red | Plate 2 | A6 | ACD13196.1 (GenBank) | Echinopora forskaliana | 32 |
| | Chromogenic Protein, | Plate 1 | F12 | | | |
| | (positive control) | | | | | |
| 164 | Rubredoxin-2 | Plate 2 | H2 | | Nitrospirae bacterium | |

### Example 2: Non-Heme Iron Protein Thermostability

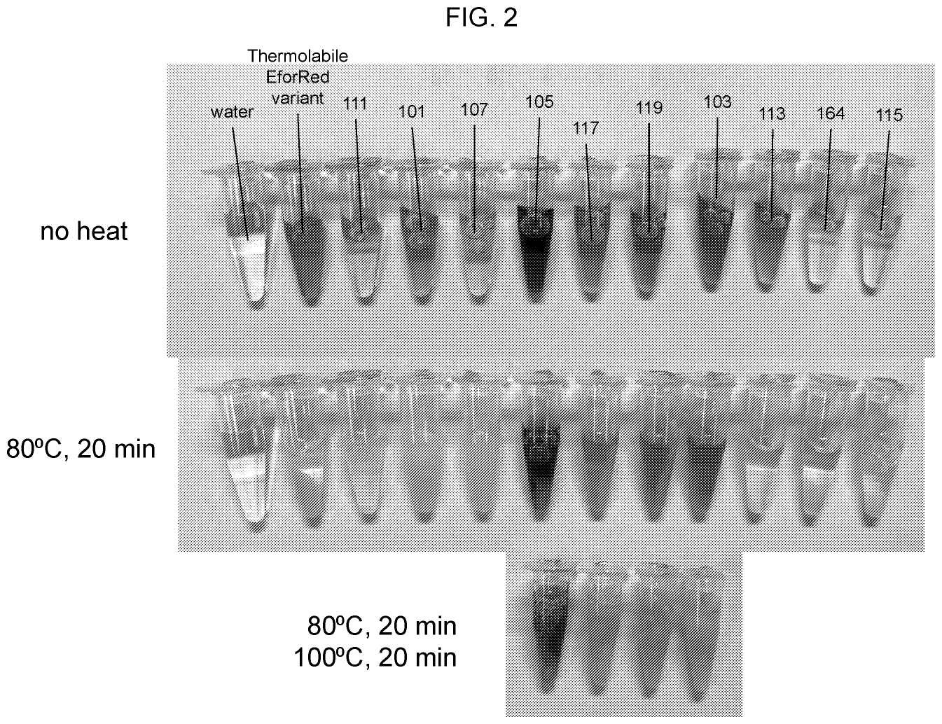

Eleven (11) non-heme iron-binding proteins (reference numbers 101, 103, 105, 107, 109, 111, 113, 115, 117, 119, and 121, see Table 3) were expressed in E. coli cells using a His6 tag with a protease cleavage site (MGSSHHHHHHSSGL VPRGSH, SEQ ID NO:33) on the N-terminus of the protein sequence (SEQ ID NOs:1-11). While all 11 non-heme iron proteins assayed were pink/red in the primary high throughput screen (Example 1), 9 of the 11 hits showed robust pink/red/brown color in this scaled up assay (FIG. 2). The 11 samples were compared to a thermolabile EforRed mutant (F68Y and A214T mutations in SEQ ID NO:32) and rubredoxin-2 from Nitrospirae bacterium 164 that did not appear red/brown in the high throughput screen.

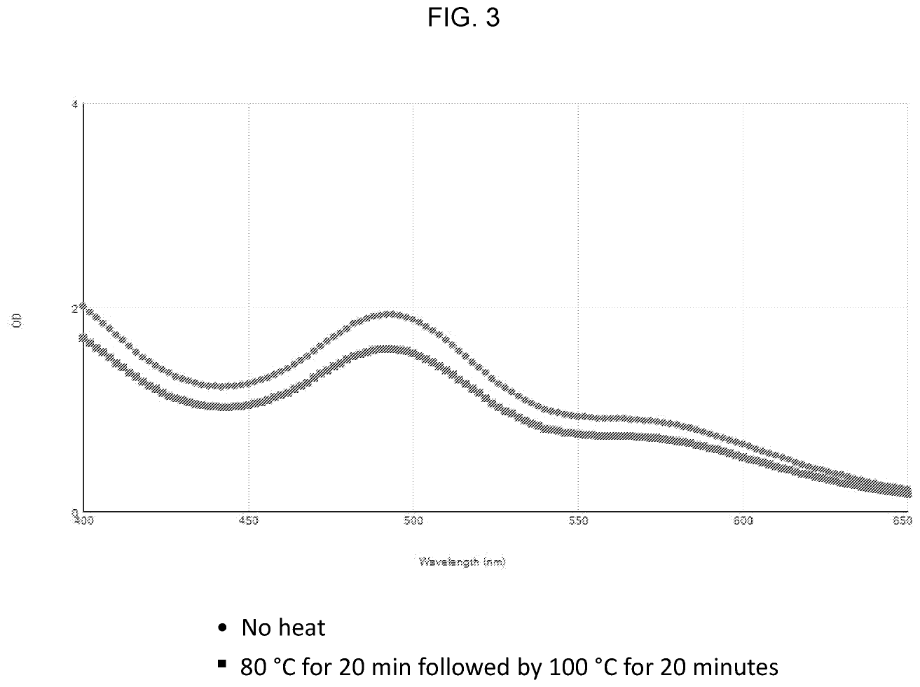

Upon heating at 80° C. for 20 minutes, four of the 11 proteins (reference numbers 105, 117, 119, and 103) remained stable and retained the red/pink color (FIG. 2). These four were heated at 100° C. for an additional 20 minutes. The rubredoxin from Crocosphaera subtropica 105 demonstrated excellent thermostability, maintaining its red/brown color (confirmed by the absorbance spectra shown in FIG. 3) after heating for 20 minutes at 80° C. and an additional 20 minute at 100° C. The other 5 proteins (reference numbers 111, 101, 107, 113, and 115) are thermolabile and lost their pink/red/brown color upon heating (FIG. 2).

### Example 3: Meat Substitute Model

Based on the thermostability and screening results, the proteins corresponding to reference numbers 101, 107, 105, 117, 119, 103, and 113 were chosen for further characterization in a small-scale application model of a meat substitute composition. Meat substitute composition including these proteins were compared to beef, meat substitute compositions including beet juice or water, and two commercially available meat substitute compositions. The small-scale application model was prepared with pea protein hydrolysate and soluble pea protein. Concentration for the proteins used in the small-scale application model are recited in Table 4.

TABLE 4

| Reference Number | Protein | Concentration (mg/g) |
|---|---|---|
| 101 | Desulfoferrodoxin | 8.9 |
| 107 | Ferritin | 6.4 |
| 105 | Rubredoxin | 4.3 |
| 117 | Desulfoferrodoxin | 6.7 |
| 119 | Desulfoferrodoxin | 8.0 |
| 103 | Desulfoferrodoxin | 17.0 |
| 113 | Hemerythrin | 9.9 |

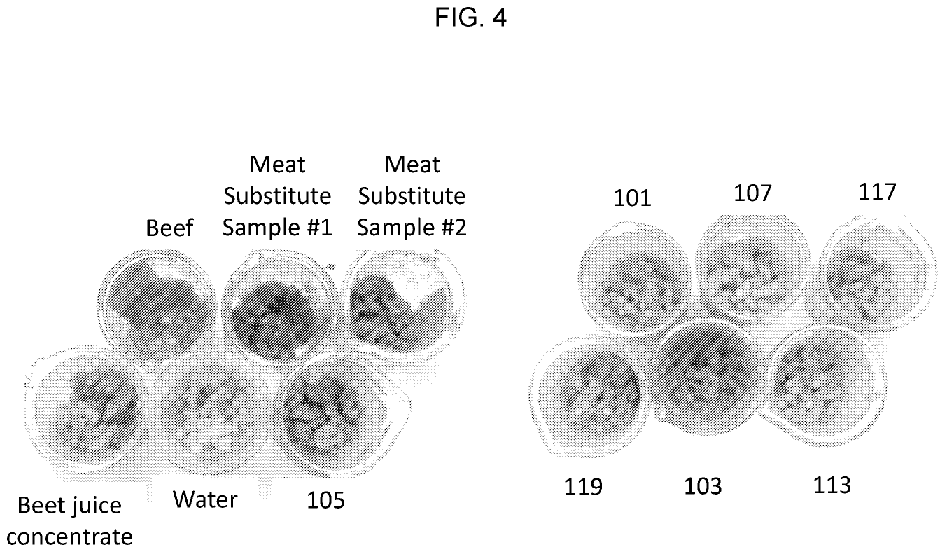

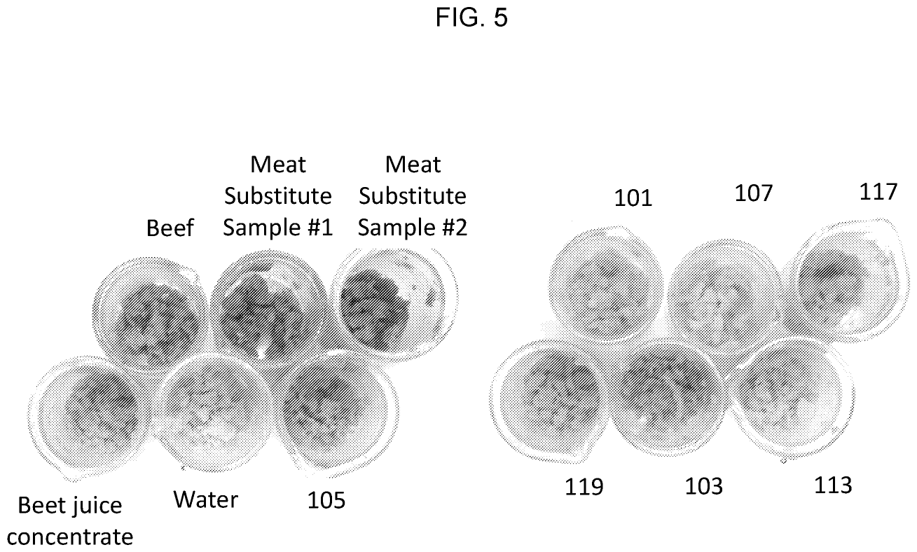

Images of the raw and cooked small-scale models are shown in FIGS. 4 and 5, respectfully, and Hunter colorimetry data for each small-scale model are reported in Table 5. Overall, the desulfoferrodoxin from Hydrogenoanaerobacterium saccharovorans 101 showed the best raw to cooked transition, indicated by the largest decrease in a*. The desulfoferrodoxin from Anaerotignum lactatifermentans 103 showed the best raw red color, indicated by the largest raw a* value.

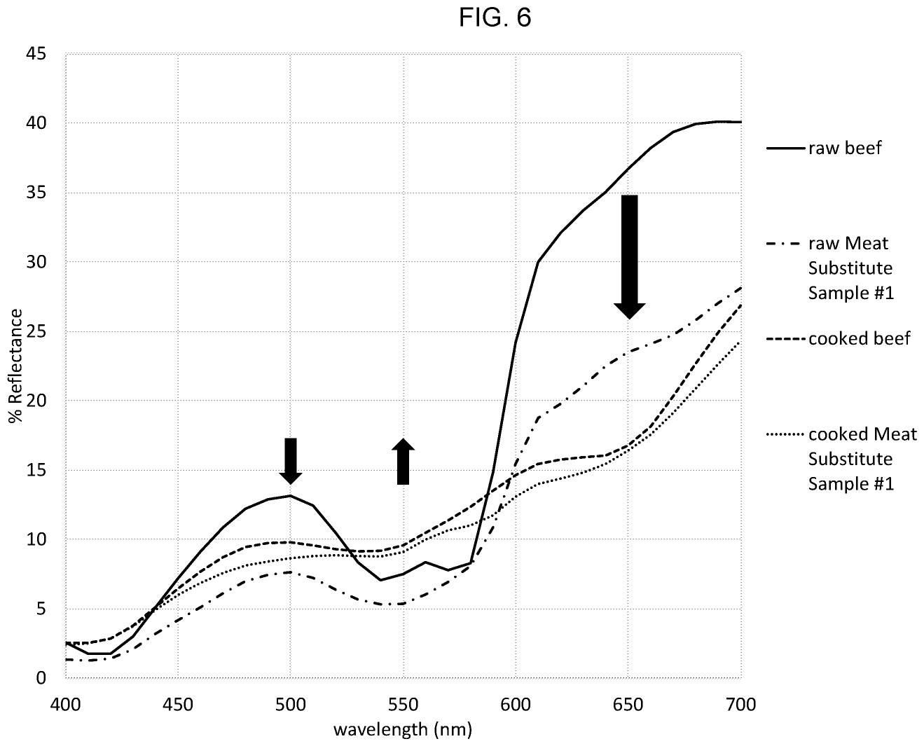

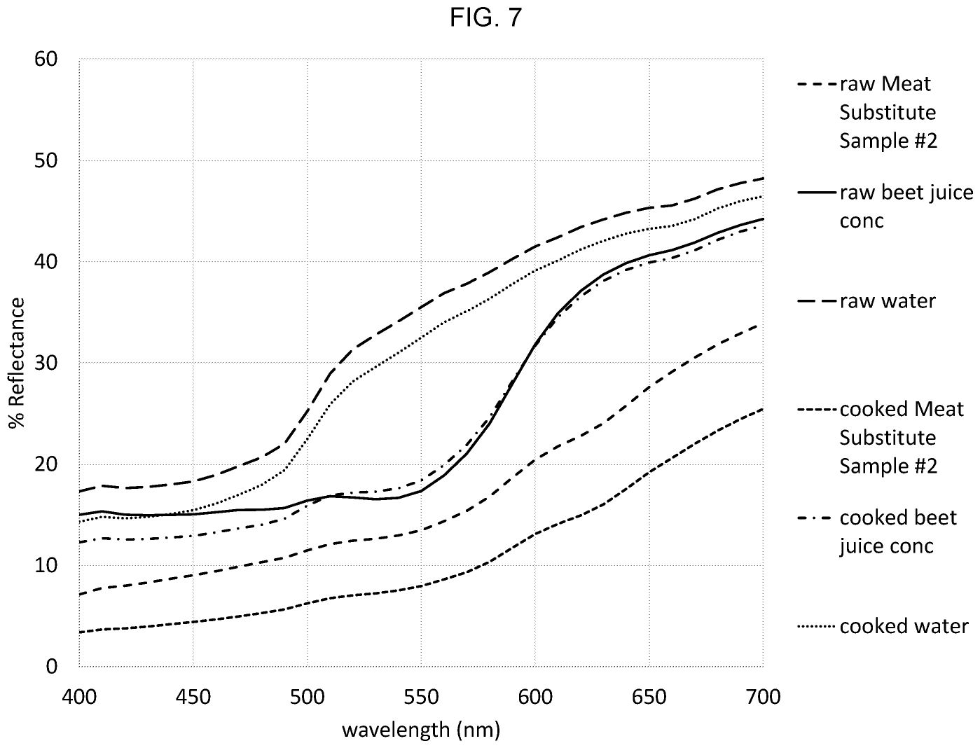

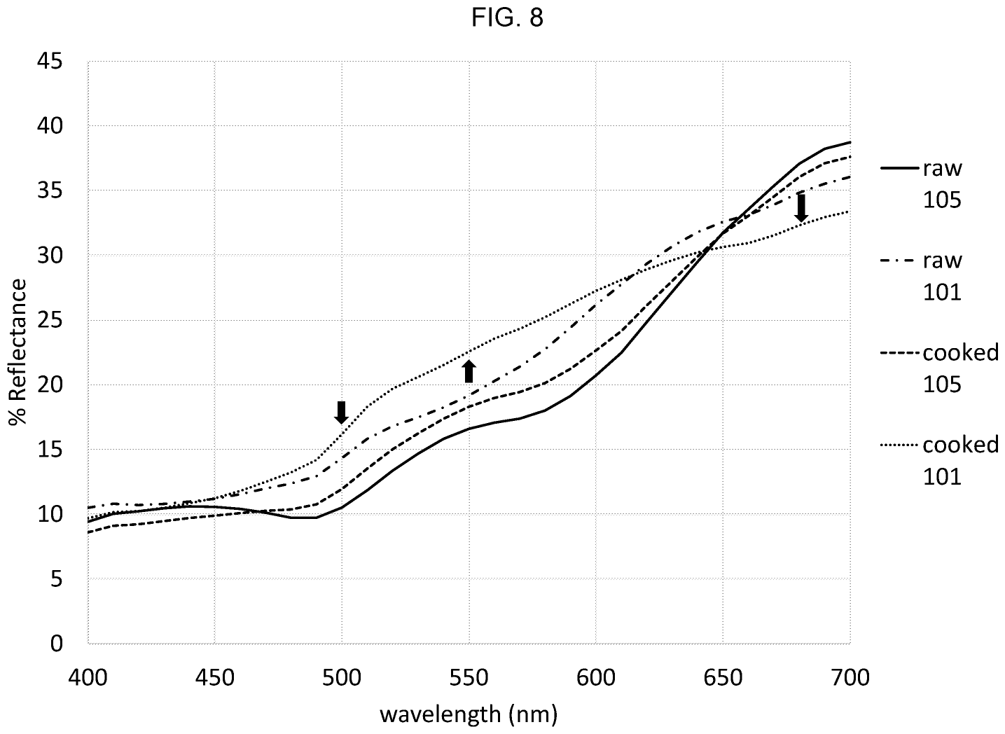

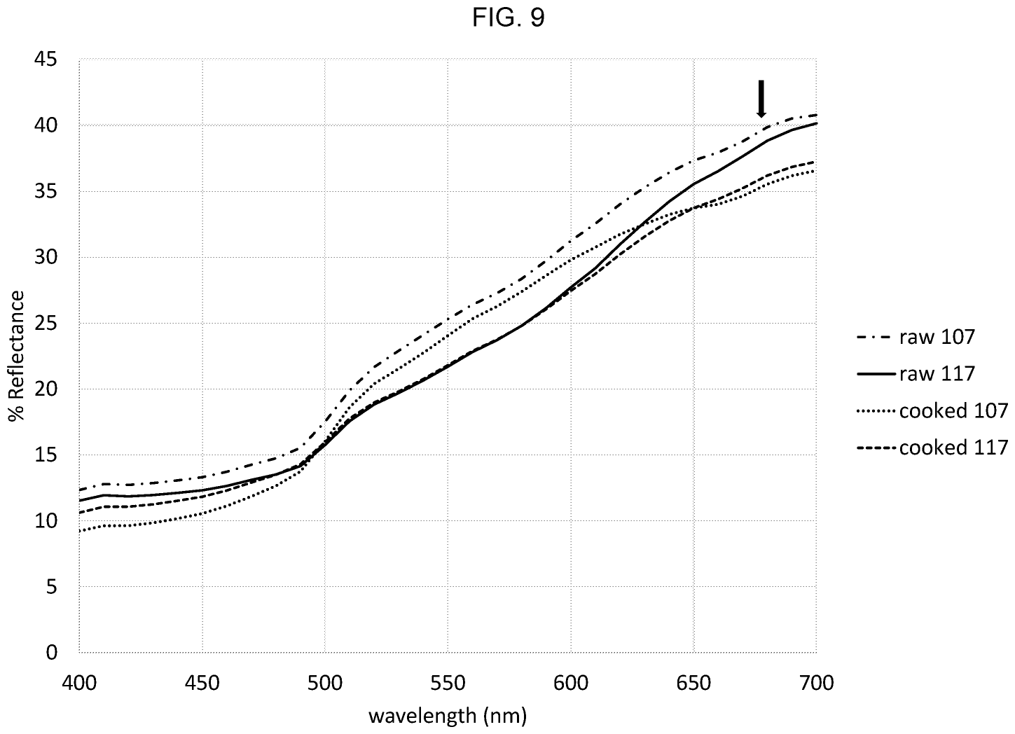

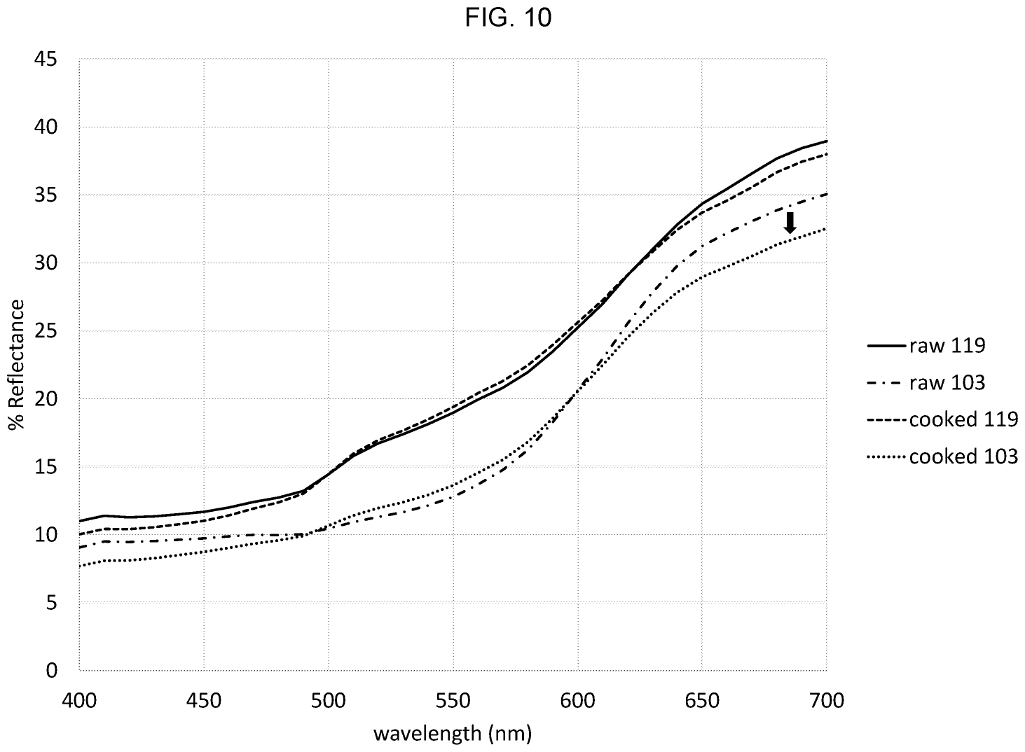

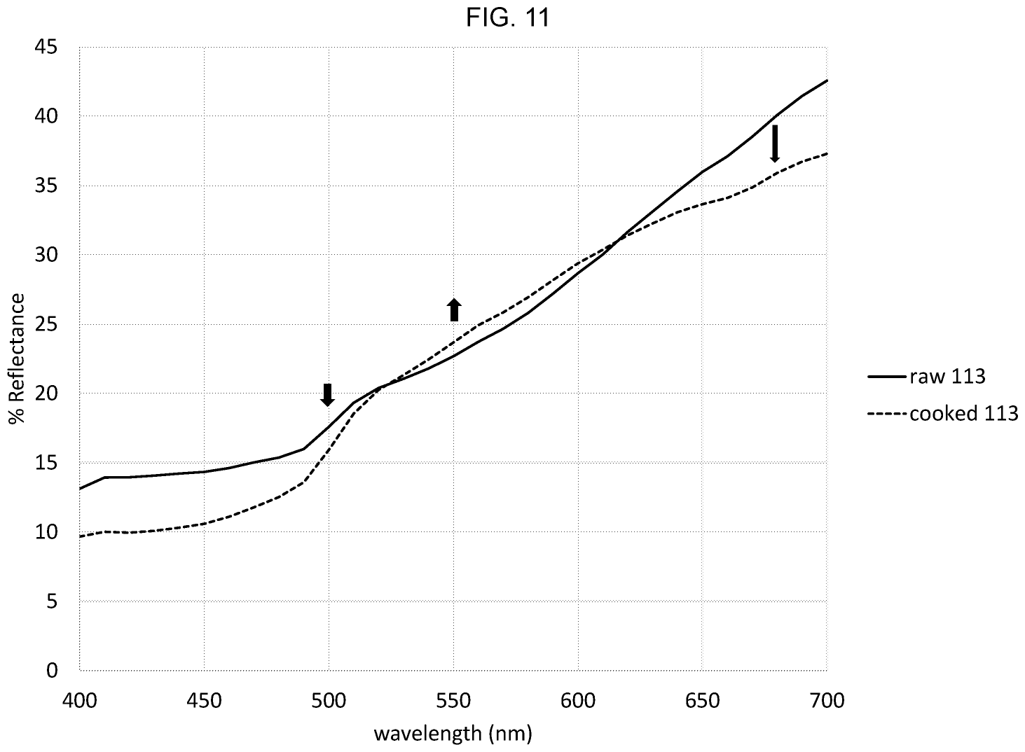

As demonstrated in FIG. 6, upon cooking, the reflectance of beef decreases between 600-700 nm, increases around 550 nm, and decreases around 500 nm, relative to the reflectance at these wavelengths when raw. These same transitions were observed between raw and cooked meat substitute sample #1 (FIG. 6). The beet juice concentrate showed slight changes in these same regions, but the water and meat substitute sample #2 showed a decease across the entire reflectance range measured (FIG. 7). The small-scale applications prepared with proteins 101 and 107 shows a decrease in reflectance between 600-700 nm upon cooking (FIGS. 8 and 9). However, the sample with protein 101 showed an increase in reflectance at 550 nm, but not the decrease at 500 nm (FIG. 8). On the contrary, the sample with protein 107 show the decrease at 500 nm but no the increase in reflectance at 550 nm (FIG. 9). The sample with protein 105 only showed the increase in reflectance at 550 nm (FIG. 8) and the sample with protein 117 only showed the decrease in reflectance at 500 nm. The sample with protein 113 shown the decrease in reflectance between 600-700 nm upon cooking as well as the decrease at 500 nm, but only a small increase around 550 nm. The sample with protein 103 showed a decrease in reflectance between 600-700 nm and a decrease at 500 nm, but only a small increase around 550 nm. Finally, the sample with protein 119 showed a very slight decrease in reflectance between 600-700 nm, but no change at either 500 nm or 550 nm upon cooking.

TABLE 5

| Sample/Reference | raw | | | | | | | cooked | | | |
|---|---|---|---|---|---|---|---|---|---|---|---|
| Number | L* | a* | b* | L* | C* | h | dE* | L* | a* | b* | L* |
| Beef | 42.8 | 21.9 | 17.8 | 42.8 | 28.2 | 39.1 | | 39.7 | 6.2 | 15.7 | 39.7 |
| Meat Substitute | 35.5 | 18.5 | 18.7 | 35.5 | 26.4 | 45.3 | 8.1 | 38.2 | 5.7 | 15.6 | 38.2 |
| Sample #1 | | | | | | | | | | | |
| Meat Substitute | 45.8 | 11.0 | 16.2 | 45.8 | 19.6 | 55.8 | 11.4 | 36.2 | 11.9 | 18.6 | 36.2 |
| Sample #2 | | | | | | | | | | | |
| Beet juice | 53.6 | 18.1 | 13.2 | 53.6 | 22.4 | 36.0 | 12.3 | 53.8 | 16.1 | 18.4 | 53.8 |
| concentrate | | | | | | | | | | | |
| Water | 65.4 | 4.7 | 25.2 | 65.4 | 25.6 | 79.4 | 29.3 | 63.1 | 5.6 | 27.4 | 63.1 |
| 101 | 47.8 | 11.7 | 15.9 | 47.8 | 19.7 | 53.7 | 11.5 | 49.7 | 9.4 | 20.4 | 49.7 |
| 101 | 52.0 | 9.9 | 19.8 | 52.0 | 22.2 | 63.4 | 15.2 | 54.2 | 5.1 | 23.2 | 54.2 |
| 107 | 57.1 | 7.5 | 22.9 | 57.1 | 24.1 | 71.9 | 20.9 | 55.7 | 6.3 | 27.4 | 55.7 |
| 117 | 54.1 | 8.8 | 20.4 | 54.1 | 22.2 | 66.7 | 17.5 | 54.0 | 7.5 | 21.4 | 54.0 |
| 119 | 51.7 | 10.2 | 18.1 | 51.7 | 20.8 | 60.7 | 14.7 | 52.0 | 9.4 | 20.3 | 52.0 |
| 103 | 45.4 | 15.8 | 13.8 | 45.4 | 21.0 | 41.0 | 7.7 | 45.8 | 12.9 | 17.3 | 45.8 |
| 113 | 55.4 | 8.1 | 17.6 | 55.4 | 19.4 | 65.2 | 18.6 | 55.4 | 6.4 | 26.8 | 55.4 |

| Sample/Reference | cooked | | | delta | | | | | |
|---|---|---|---|---|---|---|---|---|---|
| Number | C* | h | dE* | L* | a* | b* | L* | C* | h |
| Beef | 16.9 | 68.6 | | −3.2 | −15.7 | −2.1 | −3.2 | −11.3 | 29.5 |
| Meat Substitute | 16.6 | 69.9 | 1.6 | 2.7 | −12.8 | −3.2 | 2.7 | −9.8 | 24.6 |
| Sample #1 | | | | | | | | | |
| Meat Substitute | 22.0 | 57.5 | 7.3 | −9.6 | 0.8 | 2.3 | −9.6 | 2.4 | 1.7 |
| Sample #2 | | | | | | | | | |
| Beet juice | 24.5 | 48.9 | 17.5 | 0.2 | −2.1 | 5.3 | 0.2 | 2.1 | 12.9 |
| concentrate | | | | | | | | | |
| Water | 27.9 | 78.4 | 26.2 | −2.2 | 0.9 | 2.2 | −2.2 | 2.4 | −1.0 |
| 101 | 22.4 | 65.3 | 11.5 | 1.9 | −2.3 | 4.5 | 1.9 | 2.7 | 11.6 |
| 101 | 23.8 | 77.7 | 16.4 | 2.3 | −4.9 | 3.4 | 2.3 | 1.6 | 14.3 |
| 107 | 28.1 | 77.2 | 19.8 | −1.5 | −1.2 | 4.5 | −1.5 | 4.1 | 5.3 |
| 117 | 22.7 | 70.6 | 15.5 | −0.1 | −1.3 | 1.0 | −0.1 | 0.4 | 4.0 |
| 119 | 22.3 | 65.0 | 13.5 | 0.3 | −0.7 | 2.1 | 0.3 | 1.6 | 4.4 |
| 103 | 21.5 | 53.3 | 9.2 | 0.4 | −3.0 | 3.5 | 0.4 | 0.6 | 12.3 |
| 113 | 27.5 | 76.6 | 19.2 | 0.0 | −1.7 | 9.2 | 0.0 | 8.1 | 11.4 |

A summary of the results from Example 2 and 3 is provided in Table 6, outlining the proteins, their corresponding reference numbers, color intensity, color hue, heat transition, concentration produced in E. coli, normalized A500, and normalized A550.

TABLE 6

| | | | | | | A500 | A550 |
|---|---|---|---|---|---|---|---|
| Prep | | Color | Color | Heat | Concentration | Normalized | Normalized |
| number | Protein | Intensity | Hue | Transition | (mg/ml) | per mg/ml | per mg/ml |
| 1 | Hemerythrin | none | | | | | |
| 2 | Desulfoferrodoxin | medium | orange | thermolabile | 24.1 | 0.14 | 0.11 |
| 3 | Ferritin | low | pale | thermolabile | 17.2 | 0.08 | 0.04 |
| 4 | Rubredoxin | high | brown | thermostable | 11.6 | 0.61 | 0.29 |
| 5 | Hemerythrin | none | | | | | |
| 6 | Desulfoferrodoxin | medium | orange | thermostable | 18.2 | 0.15 | 0.11 |
| 7 | Desulfoferrodoxin | medium | orange | thermostable | 21.7 | 0.20 | 0.14 |
| 8 | Desulfoferrodoxin | high | red | thermostable | 46.0 | 0.29 | 0.23 |
| 9 | Rebrerythrin | low | pale | thermolabile | 3.9 | 0.10 | 0.06 |
| 10 | Hemerythrin | medium | magenta | thermolabile | 26.7 | 0.11 | 0.10 |
| 11 | Reverse Rubrerythrin | none | | | | | |
| Control | EforRED variant | high | magenta | thermolabile | 10.67 | 0.07 | 0.22 |

1. A meat substitute comprising:
at least 2.0% by weight of a non-meat protein, and
0.01% to 10.0% by weight of a non-heme iron-binding protein at least 80% identical to at least one of SEQ ID NOs:2, 9, and 10.

2. The meat substitute of claim 1, wherein, prior to cooking, the meat substitute has increased red color relative to an equivalent meat substitute lacking the non-heme iron-binding protein.

3-7. (canceled)

8. The meat substitute of claim 1, wherein the non-heme iron-binding protein comprises a sequence at least 90% identical to at least one of SEQ ID NOs: 2, 9, and 10.

9. (canceled)

10. The meat substitute of claim 1, wherein the non-meat protein comprises a plant-based protein selected from the group consisting of pea protein, soy protein, corn protein, chickpea protein, and wheat protein.

11-14. (canceled)

15. The meat substitute of claim 1, wherein the meat substitute comprises 0.01% to 6% by weight of the non-heme iron binding protein.

16. The meat substitute of claim 1, wherein the meat substitute comprises between 50% and 80% by weight of water.

17. The meat substitute of claim 1, wherein the meat substitute comprises between 1% and 10% by weight of a lipid composition comprising coconut oil, palm oil, sunflower oil, soy oil, canola oil, or combinations thereof.

18. (canceled)

19. The meat substitute of claim 1, wherein the meat substitute comprises between 5% and 30% by weight of a textured plant-based protein comprising textured pulse protein, textured pea protein, textured soy flour, textured soy concentrate, textured wheat protein, potato protein, or combinations thereof.

20. (canceled)

21. The meat substitute of claim 1, wherein the meat substitute comprises between 0.5% and 8% by weight of a powdered plant-based protein comprising pea protein isolate, soy flour, soy isolate, soy concentrate, vital wheat gluten, potato protein, corn protein isolate, or combinations thereof.

22. (canceled)

23. The meat substitute of claim 1, wherein the meat substitute comprises methylcelluose in an amount between 0.1% and 2% by weight.

24-30. (canceled)

31. A method for increasing the red color of a meat substitute, comprising:
adding between 0.1% and 10.0% by weight of a non-heme iron-binding protein to a meat substitute comprising a non-meat protein to form a meat substitute with increased red color prior to cooking relative to an equivalent meat substitute without the non-heme iron-binding protein, wherein the non-heme iron-binding protein has a sequence at least 90% identical to at least one of SEQ ID NOs:2, 9, and 10.

32-35. (canceled)

36. A plant, animal, or edible mushroom cell comprising an exogenous polynucleotide encoding an non-heme iron-binding polypeptide comprising a sequence at least 80% identical to at least one of SEQ ID NOs: 2, 9, and 10, wherein the non-heme iron-binding polypeptide has an absorption spectrum maximum between 450 nm and 600 nm.

37.

38. The cell of claim 36, wherein the cell a plant cell.

39. The cell of claim 36, wherein the cell is an edible mushroom cell.

40. The cell of claim 39, wherein the edible mushroom cell is a Fusarium venenatum cell.

41. The cell of claim 36, wherein the cell is an animal cell.

42. The cell of claim 41, wherein the cell is an insect cell.

43. The cell of claim 41, wherein the cell is an in vitro cultured mammalian or avian cell.

44. A meat substitute comprising the cell of claim 36.

45. (canceled)
